(19) United States
(12) Patent Application Publication
(10) Pub. No.: US 2023/0083611 A1
(43) Pub. Date: Mar. 16, 2023

(54) CLEANING DEVICE FOR AN OPTICAL SYSTEM

(71) Applicant: VALEO SYSTEMES D'ESSUYAGE, La Verriere (FR)

(72) Inventor: Frederic GIRAUD, La Verriere (FR)

(73) Assignee: VALEO SYSTEMES D'ESSUYAGE, La Verriere (FR)

(21) Appl. No.: 17/800,555

(22) PCT Filed: Jan. 25, 2021
(86) PCT No.: PCT/EP2021/051629

§ 371 Date: Aug. 18, 2022

(30) Foreign Application Priority Data
Feb. 28, 2020 (FR) 2002050

(51) Int. Cl. B60S 1/52; B60S 1/18; B60S 1/16; B60S 1/12

(52) U.S. Cl. CPC B60S 1/522; B60S 1/185; B60S 1/163; B60S 1/125

(57) ABSTRACT

The present invention relates to a device for cleaning at least one optical surface of a vehicle, including at least one rod which extends mainly along a longitudinal elongation axis. The rod including an element for spraying a cleaning fluid and a wiper blade configured to wipe the optical surface. The device further including at least one actuation means driven to move the rod in a first longitudinal direction of movement parallel to the longitudinal elongation axis, and in a second longitudinal direction of movement opposite to the first longitudinal direction of movement. The device additionally includes at least one means for limiting and/or compensating for at least one return force exerted on the rod.

### CROSS-REFERENCE TO RELATED APPLICATIONS

This application is filed under 35 U.S.C. § 371 U.S. National Phase of International Application No. PCT/EP2021/051629 filed Jan. 25, 2021 (published as WO2021170324), which claims priority benefit to French Application No. 2002050 filed on Feb. 28, 2020, the disclosures of which are herein incorporated by reference in their entirety.

### TECHNICAL FIELD

The present invention relates to the field of optical systems positioned within a vehicle, and more particularly it concerns the cleaning devices of such optical systems.

### BACKGROUND OF THE INVENTION

With the progress of automotive market innovation, the number of optical systems present in a vehicle, for example sensors, has increased significantly in recent years. Optical systems of this type are used in particular for driving assistance systems or for automation of driving. In this respect, the data acquired by these optical systems must be reliable despite the fact that they can be exposed to bad weather conditions, and the need to clean these systems has quickly become felt.

It is known to set up a cleaning device in the vicinity of the optical systems with a jack comprising a rod which emerges from a jack body and which sprays a cleaning fluid onto the optical system by means of a spraying element located at the emerging end of the rod. The device is implemented for example by activation of a control button by the driver, or automatically in the case of detection of dirt present on a glazed surface of the optical system. The rod then goes from a retracted position, out of a field of detection of the optical system, to a position of work in which the spraying element is facing the surface of the optical system to be cleaned. It is understood that, when the rod emerges from the jack body, the cleaning fluid can be sprayed at the level of the spraying element, or nozzle, arranged at the end of the rod, on the optical system, throughout the displacement of the rod.

### BRIEF SUMMARY OF THE INVENTION

The present invention comes within the context of a telescopic nozzle cleaning device as has just been described, wherein a wiper blade is incorporated in the device, said blade being rendered integral with the rod, such as to be able to wipe the glazed surface of the optical system after spraying of the cleaning fluid, the blade being driven by the rod in the wake of the nozzle.

However, the addition of a wiper blade to a telescopic cleaning device creates a risk of generating a problem of mechanical stress. In fact, in order to be able to wipe the surface of the optical system efficiently, the wiper blade is placed against the surface to be cleaned, and this stress generates a significant force exerted on the rod of the device. The rod is then liable to become deformed or misaligned, which can involve blockages in the emergence of the rod.

The present invention makes it possible to limit the mechanical stresses exerted on the rod, in particular by the deformation of the wiper blade on the surface to be cleaned, by proposing a device for cleaning at least one optical surface of a vehicle, comprising at least one rod which extends mainly along an axis of longitudinal extension, said rod comprising an element for spraying a cleaning fluid, and a wiper blade which is configured to wipe the optical surface, the cleaning device comprising at least one actuation means, which is controlled in order to displace the rod in a first direction of longitudinal displacement parallel to the axis of longitudinal extension, and in a second direction of longitudinal displacement, opposite the first direction of longitudinal displacement, characterized in that the cleaning device comprises at least one means for limitation of, and/or compensation for, at least one return force exerted on the rod.

The optical system can take the form for example of an image-capturing optical sensor such as a camera. It can be a CCD (charge-coupled device) sensor or a CMOS sensor comprising a matrix of miniature photodiodes. According to another example, the optical system can take the form for example of an infrared-radiation sensor such as an infrared camera. The optical system can also take the form for example of a light emitter such as a headlamp, or an optoelectronic device such as an LED.

Alternatively, the optical system can take the form for example of an electromagnetic radiation emitter-receiver such as a RADAR (Radio Detection and Ranging), for the emission and reception of radio waves, or such as a LIDAR, the acronym for “Light Detection and Ranging” for the remote laser detection, or such as an infrared sensor/emitter for the emission and reception of infrared waves.

The rod can be displaced in two directions of longitudinal displacement, these directions being parallel to the axis of longitudinal extension of the rod. The means for actuation can for example control the rod when the optical surface of the optical system to which the cleaning device is allocated needs to be cleaned, for example if it is detected that the optical surface is covered with dirt preventing satisfactory operation of the optical system. The rod is then displaced such that all of the surface of the optical system can be cleaned. The rod is displaced in the first direction of longitudinal displacement during a first cleaning phase, then in the second direction of longitudinal displacement during a second cleaning phase.

The cleaning fluid is sprayed in parallel with the displacement of the rod during the first cleaning phase. Thus, the cleaning fluid can be sprayed all along the optical surface, in order for this surface to be able to be cleaned in its entirety. Once the cleaning fluid has been sprayed on the optical surface, the wiper blade wipes the surface in order to eliminate the cleaning fluid. The wiper blade has a main dimension of extension which is substantially perpendicular to the axis of longitudinal extension of the rod. Since the cleaning fluid must be sprayed by the spraying element, then wiped by the wiper blade, the blade must be positioned at the level of the rod, downstream from the spraying element relative to the first direction of longitudinal displacement carried out by the rod during the cleaning phase.

The wiper blade is placed against the optical surface when the surface is wiped by this same wiper blade. Placing of this type permits optimal wiping of the optical surface, so that it is correctly cleaned. In order to assure that the wiper blade is in contact against the optical surface, and is placed against it, the wiper blade must have, along the corresponding axis, a dimension larger than the distance between the axis of longitudinal extension of the rod and the optical surface. This placing, which is necessary in order to carry out good cleaning, generates a return force exerted on the rod which is liable to misalign it.

More particularly, the return force is derived from a stress exerted by the optical surface on the wiper blade, which transmits this stress to the rod. As a result of its direction perpendicular to the surface to be cleaned, and thus to the axis of longitudinal extension of the rod, the return force tends to offset the rod, in particular by moving away an end of the rod comprising the spraying element. In other words, the return force which is exerted on the rod corresponds to a force which can give rise to deterioration of the rod, for example deformation, misalignment, jamming, or breakage thereof. The return force has a direction perpendicular both to the direction of longitudinal displacement of the rod, and to a main dimension of the wiper blade, which, as previously stated, is perpendicular to the axis of longitudinal extension of the rod.

The cleaning device according to the invention makes it possible to limit and/or compensate for a return force of this type, and to keep the rod functional, i.e. with its axis of longitudinal extension parallel to the direction of longitudinal displacement, and substantially parallel to a plane formed by the surface to be cleaned, i.e. the optical surface.

According to a characteristic of the invention, the wiper blade comprises a unilateral stop unit extending projecting from a single side of the wiper blade, said unilateral stop unit constituting a first means for limitation of, and/or compensation for, at least one return force exerted on the rod.

According to another characteristic of the invention, the wiper blade can comprise a heel which is integral with the rod, and a friction element which is configured to wipe the optical surface, the heel and the friction element being connected to one another by an intermediate portion, and the unilateral stop unit can extend projecting from a single side of the wiper blade, from the intermediate portion. The heel permits connection of the wiper blade to the rod. The connection can for example take place by securing the heel of the wiper blade in a blade support which is secured on the rod However, any connection means can be envisaged, the essential thing being to maintain good operation of the wiper device, without mechanical interference.

The friction element is positioned opposite the rod. It is this friction element which wipes the optical surface of the optical system. Since the wiper blade is made of deformable material, for example rubber or flexible synthetic material, the friction element can be deformed under the effect of the contact with the optical surface as well as of the displacement of the rod. The heel and the friction element can for example be connected by a strip of flexible material which constitutes the intermediate portion.

The friction element is deformed in the direction opposite the direction of longitudinal displacement which the rod carries out. The unilateral stop unit projects from a single side of the intermediate portion of the wiper blade, such that it forms a stop in contact with the friction element when the element is deformed only in a single direction of displacement. The unilateral stop unit limits the deformation of the friction element by placing it against the optical surface, the unilateral stop unit thus making it possible to optimize the efficiency of wiping of the wiper blade when the rod is displaced in a given direction of displacement.

The side of the wiper blade on which the unilateral stop unit is positioned is selected such as to ensure that the friction element is maintained placed against the optical surface despite the deformation thereof, when the rod is displaced in the first direction of longitudinal displacement.

When the rod is displaced in the second direction of longitudinal displacement, i.e. after the phase of cleaning of the cleaning device, it is no longer necessary to place the friction element against the optical surface. Since the stop unit has a unilateral characteristic, this results in the absence of a second stop unit which places the friction element against the optical surface when the rod is displaced in the second direction of longitudinal displacement. The friction element will thus slide along the optical surface without being placed on it, which thus attenuates the return force exerted on the rod.

According to a characteristic of the invention, the unilateral stop unit is oriented towards the means for actuation of the rod. In other words, the unilateral stop unit extends projecting from the intermediate portion of the wiper blade in the direction of the means for actuation of the rod. As previously indicated, the orientation of the unilateral stop unit makes it possible to place the friction element against the optical surface only in a direction of longitudinal displacement.

According to a characteristic of the invention, the means for actuation of the rod is in the form of a jack comprising a jack body delimiting a chamber and a piston which can be displaced within the jack body, the piston being connected to an end of the rod, the rod being able to emerge at least partly outside the jack body, and to return at least partly within the jack body according to a direction of displacement of the piston within the jack body, said jack body comprising a tubular portion, a longitudinal end of which comprises a first terminal wall provided with an opening which permits the passage of the rod.

The jack can for example be controlled pneumatically, hydraulically or electrically. The jack body is configured to permit the emergence of the rod out of it. The piston is positioned on an end of the rod. It is therefore the displacement of the piston which causes the emergence of the rod out of the jack body, but also the return of the rod within the jack body once the first cleaning phase of the optical system has been carried out. It is thus understood that the displacements of the rod in both directions of longitudinal displacement are permitted by freedom of displacement in translation of the piston outside the jack body. The jack body and the piston can for example have a cylindrical form, with the piston having a diameter which is substantially smaller than a diameter of the jack body, in order to be able to be displaced therein. The displacement of the piston can be initiated by the entry of a fluid into the chamber, said fluid exerting a thrust force on the piston in order to displace it. The piston can also be controlled electrically.

The tubular portion of the jack body can for example be cylindrical, and it is partly delimited by the first terminal wall. It is by means of the first terminal wall that the rod emerges from the jack body and returns within it. The opening of the first terminal wall advantageously matches the form of the rod, to within the play. The dimension of the opening of the first terminal wall, for example the diameter, can be substantially equivalent to a thickness of the rod. Thus, in a configuration of this type, the rod can slide through the opening longitudinally, while preventing the leakage of fluid through this first terminal wall. Under the influence of the return force exerted by the optical surface on the rod, the opening of the first terminal wall can form a lever around which the rod can tilt, by means of a moment of force generated by said return force, and the one or more means for limitation of, and/or compensation for, at least one return force exerted on the rod according to the invention are configured to attenuate this moment of force by decreasing the intensity of the return force and/or in order to generate a moment of compensation, in the opposite direction, for the moment generated by the return force.

In the case when the rod and the opening have a circular form, the cleaning device can comprise an anti-rotation device which makes it possible to prevent the rotation of the rod around its axis of extension and displacement in translation. By way of non-limiting example, an anti-rotation device of this type can consist of a groove extending along the rod, and of a protuberance which is situated at the opening, and has a form complementary to the groove of the rod. The receptacle for the protuberance in the groove permits sliding of the rod along the opening, but prevents the rotation of the rod within the opening.

According to a characteristic of the invention, the jack body comprises a second terminal wall comprising an orifice for intake of the cleaning fluid. The second wall delimits the tubular portion, while being longitudinally opposite the first terminal wall. Thus, each of the terminal walls determines the course of the piston which can be displaced longitudinally from one terminal wall to the other. In the case of a hydraulic jack, the second terminal wall also makes it possible to delimit a buffer area with a volume which is variable as the piston is displaced, which area extends from the piston as far as the second terminal wall.

According to a characteristic of the invention, the rod comprises at least one channel for circulation of the cleaning fluid, which connects the orifice for intake of the cleaning fluid to the spraying element. The circulation channel extends through the piston and the rod, until it reaches the spraying element. Thus, the cleaning fluid circulates within this circulation channel in order to be sprayed against the optical surface of the optical system by means of the spraying element. Advantageously, the diameter of the circulation channel is such that the cleaning fluid can be admitted there under high pressure, and thus be sprayed efficiently against the optical surface.

The connection between the cleaning fluid intake orifice and the circulation channel in order for the cleaning fluid to be able to circulate from one to the other can be established in different manners. In the case of an example of a hydraulic jack, the cleaning fluid can flow via the cleaning fluid intake orifice and fill the buffer area. In a configuration of this type, the cleaning fluid also acts as a thrust fluid, driving the displacement of the piston, while being introduced into the circulation channel in order to reach the spraying element, so as to be sprayed on the optical surface of the optical system. According to another example of a hydraulic jack, or in an example of a pneumatic jack, the fluid intake orifice and the circulation channel can be connected for example by a tube, the piston being configured to slide along the tube. The cleaning fluid thus passes directly from the intake orifice to the circulation channel via the tube, and it is a secondary fluid which is injected into the buffer area in order to assure the thrust of the piston. The secondary fluid can for example be water in the case of a hydraulic jack, or compressed air in the case of a pneumatic jack.

According to a characteristic of the invention, the piston comprises a connection face from which the rod extends, and a support face which is configured to withstand a thrust force exerted by a fluid which is present in the chamber, said support face having inclination relative to a plane perpendicular to the axis of longitudinal extension of the rod. In other words, the connection face and the support face are faces opposite one another in the direction of displacement of the piston, the connection face being oriented towards the first terminal wall of the jack body, and the support face being oriented towards the second terminal wall of the jack body. The piston can be centered around the axis of extension of the rod. In the case when the piston has a form of revolution, the axis of extension of the rod corresponds to an axis of revolution of the jack body, of the piston and of the rod.

The connection face of the piston is perpendicular to the axis of extension of the rod. The support face for its part is inclined relative to a plane perpendicular to the axis of extension of the rod. Thus, the connection face and the support face not parallel to one another. Modifying the inclination of the support face of the piston gives rise to modification of a global direction of the thrust force exerted by the fluid on the piston. The thrust force thus has a longitudinal component which permits displacement of the piston, and a vertical component in the same direction as the return force exerted by the optical surface on the rod. The vertical component thus makes it possible to compensate for moment which is derived from the return force and is exerted on the rod, thus preventing effects of jamming, inter alia. Said moment can pivot the rod around the lever formed by the opening of the first terminal wall previously described. The vertical component of the thrust force makes it possible to generate a moment of compensation for this moment of force, i.e. moment around the lever in the direction opposite that of the moment generated by the return force, in order to prevent the misalignment of the rod, when it is displaced in the first direction of displacement during the first cleaning phase. Depending on the type of jack, the thrust force is exerted by the cleaning fluid or by the secondary fluid.

According to a characteristic of the invention, the piston has a guide surface with a longitudinal dimension which is larger than the mean longitudinal dimension of the piston, said guide surface being facing an area of the tubular portion of the jack body which is opposite the wiper blade relative to a plane comprising the axis of longitudinal extension of the rod and a main dimension of extension of the wiper blade, with the piston constituting a second means for limitation of, and/or compensation for, at least one return force exerted on the rod. The longitudinal dimension of the piston corresponds to the dimension which is perpendicular to the connection face, and extends between the connection face and the support face of the piston. In other words, the longitudinal dimension of the piston corresponds to the thickness of the piston measured between the connection face and the support face. In the context previously described wherein the support face has inclination relative to the plane perpendicular to the axis of longitudinal extension of the rod, and the faces of the piston are not parallel to one another, the longitudinal dimension of the piston develops regularly from one edge of the piston to an opposite edge of the other side of the mean longitudinal axis of the piston. The inclination is configured such that the longitudinal portion of the piston which has the largest longitudinal dimension, in this case known as the guide surface, is situated opposite the wiper blade relative to the plane comprising the axis of longitudinal extension of the rod and the main dimension of the wiper blade.

A configuration of this type is useful when the cleaning device is in the second cleaning phase i.e. when the rod is displaced in the second direction of longitudinal displacement, and returns into the jack body. The contact between the wiper blade and optical surface always generates a return force exerted on the rod. During this displacement, the guide surface assures a surface of contact with the tubular portion which is sufficiently large in the direction of displacement to assure a fluid slide movement, so as to limit the risks of misalignment of the rod.

The piston, and more particularly the form thereof resulting from the inclination of the support face, thus constitutes a second means for limitation of, and/or compensation for, the return force exerted on the rod. The manner of limiting this return force differs from the first means for limitation and/or compensation in that, where the first means for limitation and/or compensation attenuates the return force exerted on the rod, the second means for limitation and/or compensation compensates for the return force exerted on the rod by generating a moment of force with a direction opposite that of the moment of force generated by the return force exerted on the rod by the optical surface via the wiper blade. It can perfectly well be envisaged to combine the two means for limitation and/or compensation within the same cleaning device, in order to provide the maximum guarantee of the rod being retained in a position which is parallel, or substantially parallel, to its original position.

The second means for limitation and/or compensation is active when the rod is displaced in the first direction of longitudinal displacement and in the second direction of longitudinal displacement. It is thus distinguished from the first means for limitation and/or compensation, which is active only when the rod is displaced in the second direction of longitudinal displacement.

The invention also covers a system for cleaning at least one optical system of a vehicle, comprising at least one cleaning device as previously described, a cleaning fluid reservoir and a pump which transfers the cleaning fluid from the reservoir to the spraying element.

The cleaning fluid reservoir stores the fluid waiting to be used. The pump is activated for example further to a manual command given by a user of the vehicle, or automatically after detection of obstruction of a field of vision of the optical surface of the optical system. The cleaning fluid is thus aspirated by the pump, and circulates in a duct until the duct opens out at the entry orifice of the second terminal wall of the jack body, in order to flow in the circulation channel, then be sprayed onto the optical surface via the spraying element.

### BRIEF DESCRIPTION OF THE DRAWINGS

Further characteristics and advantages of the invention will become more clearly apparent both from the following description and from a number of embodiments, which are provided by way of non-limiting indication with reference to the appended schematic drawings, in which:

FIG. 1 is a schematic representation of a cleaning system comprising a cleaning device according to a first embodiment;

FIG. 2 is a schematic representation of the cleaning system in FIG. 1, when a rod of the cleaning device is displaced in a first direction of longitudinal displacement;

FIG. 3 is a schematic representation of the cleaning system in FIG. 1, when the rod of the cleaning device is displaced in a second direction of longitudinal displacement;

FIG. 4 is a schematic representation of a cleaning system comprising a cleaning device according to a second embodiment, when the rod of said device is displaced in a first direction of longitudinal displacement;

FIG. 5 is a schematic representation of a cleaning system comprising a cleaning device combining the first embodiment and the second embodiment.

### DETAILED DESCRIPTION OF THE INVENTION

FIG. 1 represents a cleaning system 1 for a transparent optical surface of an optical system, not represented here as a whole. Hereinafter, reference will be made to an optical surface of an optical system without this however limiting the type of optical system and surface to be cleaned, which can be associated with the cleaning system according to the invention.

The cleaning system 1 comprises a cleaning device 2 which assures the function of cleaning the optical surface 7. The optical surface 2 is in the form of a jack 3 which can give rise to displacement of a rod 4 when the cleaning system 1 is active, with the rod supporting means for cleaning of the optical surface 7. The jack 3 thus acts as a means for actuation of these cleaning means.

The jack 3 comprises a jack body 31 delimiting a chamber 32, said chamber 32 corresponding to an inner volume of the jack body 31. The jack body 31 can for example have a cylindrical form which is defined by a tubular portion 33. The tubular portion 33 is closed at each end by a first terminal wall 34 and a second terminal wall 35.

The rod 4 has an axis of longitudinal extension 100 extending in a direction parallel to an axis of revolution of the jack body, which in this case is parallel to the optical surface 7 to be cleaned. The rod 4 is partly contained in the chamber 32 of the jack body 31, and emerges therefrom through the first terminal wall 34, which is provided with an opening 38 allowing the rod 4 to emerge from the jack body 31. An end of the rod 4 emerging from the jack body 31 comprises a joining piece 43 provided with a spraying element 41. The spraying element 41 serves the purpose of spraying a cleaning fluid 14 onto the optical surface 7, when this surface needs to be cleaned. As a result, the spraying element 41 is oriented facing the optical surface 7, in order for the cleaning fluid 14 to be able to be sprayed there.

The cleaning device 2 also comprises a wiper blade 6. The wiper blade 6 has a main direction of extension which extends perpendicularly to the rod 4. The wiper blade 6 comprises a heel 61 which permits the connection between the wiper blade 6 and the rod 4. A connection of this type can be formed in various ways, provided that it does not generate mechanical interference within the cleaning device 2. The wiper blade 6 comprises a friction element 62, which is situated at an opposite end of the heel 61. The friction element 62, which for example can be made of rubber or flexible synthetic material, serves the purpose of wiping the optical surface 7 in order to participate in the cleaning thereof Like the spraying element 41, the wiper blade 6 is oriented facing the optical surface 7. The heel 61 and the friction element 62 are connected to one another by an intermediate portion 65. This portion makes it possible to extend the wiper blade 6 such that the friction element 62 can be in contact with the optical surface 7.

The wiper blade comprises a unilateral stop unit 63, which projects from a single side of the blade, and more particularly from the intermediate portion 65. The unilateral stop unit 63 extends over the entire main dimension of the wiper blade 6, and is oriented towards the jack body 31, such as to be opposite the joining piece 43. The stop unit is said to be unilateral, in that it extends only on this blade side, with the opposite side of the blade being without a similar stop unit.

A piston 5 is connected to the end of the rod 4 opposite the end comprising the joining piece 43. In other words, the rod 4 comprises a first end which is positioned in the piston body, and is connected to the piston 5, and a second, longitudinally opposite end, which is connected to the joining piece 43. The piston 5 can be displaced within the jack body 31, and thus drives the rod 4 according to this same displacement. The displacement of the piston 5 and the rod 4 is centered on the axis of longitudinal extension 100. In the example illustrated, since the piston 5 and the rod 4 have a cylindrical form with a circular cross-section, in an original position of the rod the axis of longitudinal extension 100 also corresponds to an axis of revolution of the piston 5 and of the rod 4, which matches or substantially matches the corresponding axis of revolution of the jack body.

The piston 5 has a cylindrical form which is delimited longitudinally by a connection face 51 and a support face 52. On a plane perpendicular to the axis of extension of the jack body 31, the dimensions of the piston 5 are slightly smaller than the corresponding dimensions of the tubular portion 33 of the jack body 31, such as to permit the sliding of the piston 5 within the jack body 31. In particular, when the jack body 31 and the piston 5 have a cylindrical form with a circular cross-section, the piston 5 has a diameter which is substantially smaller than the diameter of the tubular portion 33 of the jack body 31, the piston 5 being centered on the axis of longitudinal extension 100, like the jack body 31 and the rod 4.

The connection face 51 is oriented towards the first terminal wall 34. The rod 4 is connected directly to the piston by the connection face 51. The support face 52 is oriented towards the second terminal wall 35.

The piston 5 and the rod 4 both have a circulation channel 42 passing through them. This channel is mainly centered on the axis of longitudinal extension 100, and extends along the piston 5 and the rod 4 from the support face 52 of the piston, onto which it opens out, as far as the spraying element 41. The circulation channel 42 has dimensions, in particular of its diameter, such that the cleaning fluid 14 circulates from the jack body 31, before being sprayed onto the optical surface 7 by the spraying element 41, at a defined pressure which is necessary for efficient cleaning.

The chamber 32 accommodates a spring 36, which extends from the first terminal wall 34 until it is supported on the connection face 51 of the piston 5. In order not to interfere with the rod 4, the spring 36 extends around the rod. In its initial position, i.e. when the cleaning system 1 is inactive, the spring 36 is entirely relaxed. When the cleaning system 1 is inactive, the piston 5 is thus retained in contact, or substantially in contact, with the second terminal wall 35, thanks to the spring 36. When the cleaning system 1 is active, the spring 36 can be compressed under the effect of the displacement of the piston 5.

The cleaning system 1 comprises a reservoir 11 for cleaning fluid 14. It is in this reservoir 11 that the cleaning fluid 14 is stored when the cleaning system 1 is inactive. The reservoir 11 can be resupplied with cleaning fluid 14 by a user of the vehicle. In order for the cleaning fluid 14 to be able to circulate as far as the cleaning device 2, the cleaning system 1 comprises a duct 13 which connects the reservoir 11 to an intake orifice 37 which is arranged at the second terminal wall 35, in order for the cleaning fluid 14 to be able to emerge into the chamber 32. A pump 12 is positioned on the duct 13, and makes it possible to aspirate the cleaning fluid 14 which is stored in the reservoir 11, and to make it circulate as far as the cleaning device 2. A cleaning phase by the cleaning system 1 is initiated when the pump 12 is put into operation. Putting into operation of this type of the pump 12 can be derived from a manual command executed by a user of the vehicle, or also automatically if the optical system is provided with a detector indicating that the optical surface 7 is obstructed, and needs to be cleaned.

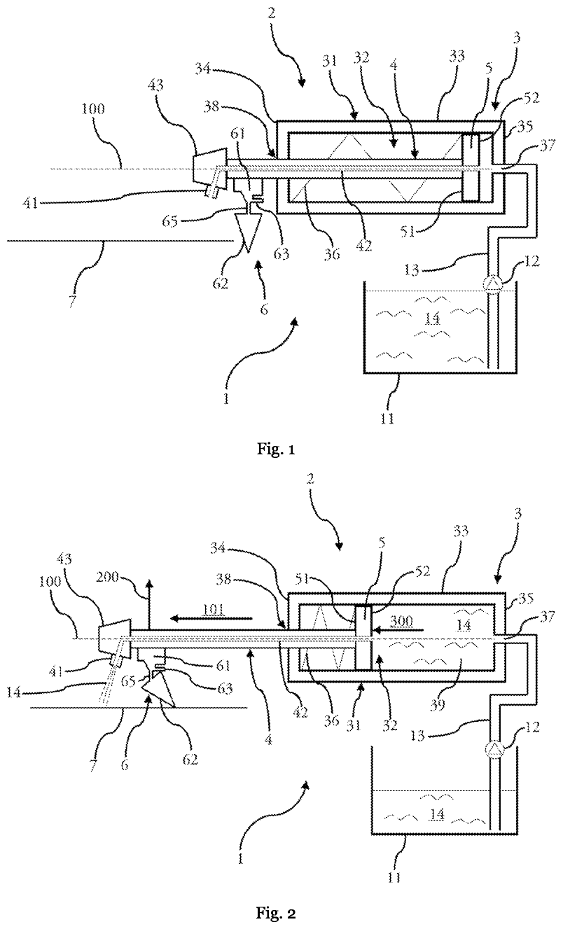

FIG. 2 represents the cleaning system 1 as represented in FIG. 1, this time during a first cleaning phase. The pump 12 is thus put into operation and aspirates the cleaning fluid 14 from the tank 11. The cleaning fluid 14 circulates in the duct 13 as far as the intake orifice 37, and flows into the chamber 32 of the jack body 31, more specifically into a buffer area 39 which is formed between the piston 5 and the second terminal wall 35. The pressure of the cleaning fluid 14 filling the chamber 32 is such that a thrust force 300 is exerted on the piston 5, perpendicularly or substantially perpendicularly to the support face 52, in a manner opposite to the force exerted by the spring 36. A thrust force 300 of this type then generates the displacement of the piston 5 in a direction parallel to the axis of longitudinal extension 100, as soon as the pressure which is exerted by the cleaning fluid 14 is greater than the pressure exerted on the piston 5 by the spring 36. In other words, the piston 5 is displaced from the second terminal wall 35 to the first terminal wall 34. The displacement of the piston in the direction of the first terminal wall 34 tends to compress the spring 36 as the piston 5 is displaced. Since the rod 4 is connected to the piston 5 at the connection face 51, the rod 4 is displaced in a first direction of longitudinal displacement 101, parallel to the axis of longitudinal extension 100.

While exerting the thrust force 300 on the piston 5, the cleaning fluid 14 is partly admitted into the circulation channel 42. Since the diameter of the channel is significantly smaller than the diameter of the chamber 32, the cleaning fluid 14 circulates in the circulation channel 42 under high pressure, as far as the spraying element 41. This results in high-pressure spraying of the cleaning fluid 14 onto the optical surface 7, in order to clean the surface. The displacement of the piston 5 and the rod 4 is carried out simultaneously with the spraying of the cleaning fluid 14 against the optical surface 7. Thus, the rod is displaced along the optical surface 7, while spraying the cleaning fluid 14 continuously. The cleaning fluid is thus sprayed along the entire optical surface 7, which optimizes the cleaning thereof.

It should be noted that the displacement of the piston 5 and the rod 4 also generates the displacement of the wiper blade 6, in a direction parallel to the axis of longitudinal extension 100. In the direction of emergence of the rod 4, the wiper blade 6 is in contact with a portion of the optical surface 7 to be cleaned, after the surface has been sprayed with cleaning fluid 14. In other words, once the cleaning fluid 14 has been sprayed onto the optical surface 7, the wiper blade 6 wipes the optical surface 7. The friction element 62 comes into contact with the optical surface 7, and wipes it in order to discharge the cleaning fluid 14, or for example wipes drops of rain off in the case of bad weather conditions.

During the contact between the optical surface 7 and the wiper blade 6, the heel 61 remains fixed, whereas the friction element 62, which forms the free end of the wiper blade 6, is retained by friction by the optical surface 7. This results in pivoting of the friction element 62, at the intermediate portion 65, around an axis which is parallel to the dimension of extension of the wiper blade 6.

In this context, and as can be seen in FIG. 2, the part of the friction element 62 which faces towards the jack body 31 tends to be raised and move away from the optical surface 7. In the first direction of longitudinal displacement 101 of the rod 4, the pivoting is blocked by the presence of the unilateral stop unit 63, which is arranged on the intermediate portion 65 of the side facing towards the jack body 31. The unilateral stop unit 63 is thus positioned on the intermediate portion 65, such that, when the friction element 62 abuts the unilateral stop unit 63, the contact is maintained between the friction element 62 and the optical surface 7. The unilateral stop unit 63 thus makes it possible to maintain the friction element 62 placed against the optical surface 7, and to optimize the wiping of the optical surface 7 by the wiper blade 6.

The placing of the friction element 62 against the optical surface 7 by means of the unilateral stop unit 63 generates a return force 200, which tends to space the wiper blade 6 and the rod 4 which supports it from the optical surface 7. This return force 200 is perpendicular both to the first direction of longitudinal displacement 101 of the rod 4, and to the main dimension of the wiper blade 6.

This return force 200 tends to misalign the rod 4 relative to its original position, which can cause a risk of damaging the cleaning device 2, and at least block the emergence and return of the rod 4 from and into the interior of the jack body 31. In the direction of the emergence, which corresponds to the first direction of longitudinal displacement 101, the thrust force 300 which is exerted by the cleaning fluid 14 on the piston 5 is sufficiently great to compensate for this tendency of the rod to become misaligned as a result of the return force 200. In other words, when the rod 4 is displaced in the first direction of longitudinal displacement 101, the return force 200 can be negligible if the thrust force 300 is significant, for example when the cleaning fluid 14 is conveyed into the chamber 32 for example at a pressure of 10 bars.

The rod 4 is displaced in the first direction of longitudinal displacement 101 until the piston 5 is in contact, or substantially in contact, with the first terminal wall 34, and can no longer be displaced in the first direction of longitudinal displacement 101. The cleaning device 2 then has an emerged position, in which the rod 4 is at the end of its course, and the spraying element 41 is as far as possible from the jack body 31.

According to the example of a cleaning device 2 presented in FIG. 1 and FIG. 2, it is the cleaning fluid 14 which, in addition to being sprayed on the optical surface 7, assures the displacement of the piston 5. It is however possible for this function to be assured by a secondary fluid, with the cleaning fluid 14 being in this case conveyed directly from the duct 13 to the circulation channel 42.

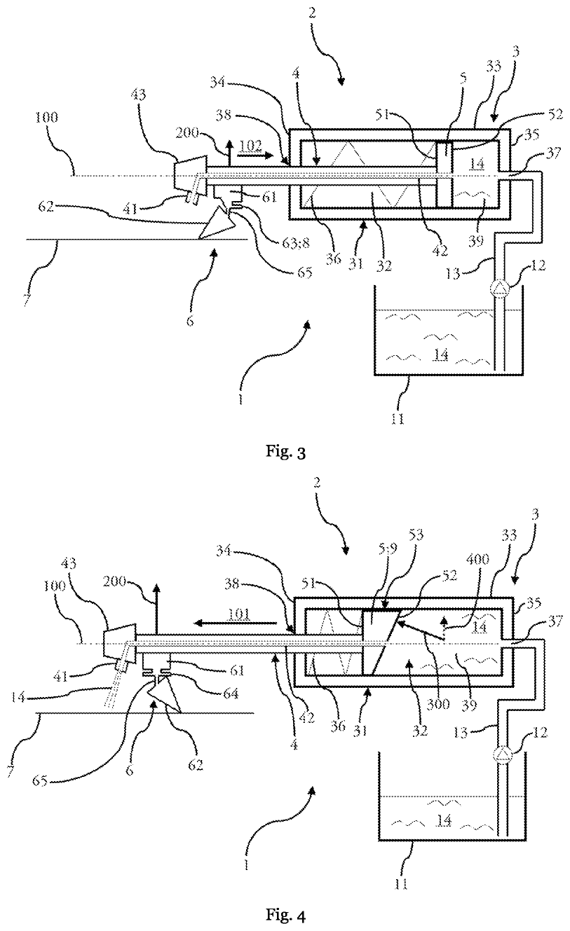

FIG. 3 corresponds to the cleaning system 1 presented in FIG. 1 and FIG. 2, during a second cleaning phase. This phase is initiated by interruption of the pump 12. The cleaning fluid 14 then no longer circulates from the reservoir 11 to the chamber 32, and consequently no longer exerts the thrust force on the piston 5. The resilient return force of the spring 36, which until then had been compressed between the piston 5 and the first terminal wall 34, becomes a greater force than that which is exerted by the cleaning fluid 14 on the piston 5, and the spring 36 thrusts the piston, relaxing progressively in order to regain its initial form as represented in FIG. 1. The relaxation of the spring 36 gives rise to displacement of the piston 5 from the first terminal wall 34 towards the second terminal wall 35. The rod 4 is driven by the displacement of the piston 5, and is thus displaced in a second direction of longitudinal displacement 102, in a direction parallel to the axis of longitudinal extension 100, and opposite the first direction of longitudinal displacement described in FIG. 2.

During its displacement, the piston 5 thrusts the cleaning fluid 14 which has remained in the chamber 32 towards the intake orifice 37. The cleaning fluid 14 is then driven into the duct 13, and returns to the reservoir 11, following the inverse path to that which has been described in FIG. 2. Since the duct 13 has a larger diameter than the diameter of the circulation channel 42, the cleaning fluid 14 flows as a matter of strong priority into the duct 13 rather than into the circulation channel 42.

During this second cleaning phase, the rod 4 is thus displaced in the second direction of longitudinal displacement 102. The cleaning fluid 14 is no longer sprayed by the spraying element 41. However, the wiper blade 6 remains in contact with the optical surface 7 by means of the friction element 62. This element is thus deformed, and pivots in the direction opposite to the second direction of longitudinal displacement 102. In this context, and as can be seen in FIG. 3, the part of the friction element 62 which faces towards the joining piece 43 tends to be raised and move away from the optical surface 7.

Since the unilateral stop unit 63 is oriented towards the jack body 31, the friction element 62 is thus not in contact with any stop unit, and can thus be released from the optical surface 7. In other words, when the rod 4 is displaced in the second direction of longitudinal displacement 102, the friction element 62 is not placed against the optical surface 7 by any stop unit. The friction element 62 is however still in contact with the optical surface 7, and slides along it. Since the wiping against the optical surface 7 has already been carried out when the rod 4 was being displaced in the first direction of longitudinal displacement 101, it is not necessary to assure optimal wiping when the rod 4 is being displaced in the second direction of longitudinal displacement 102.

Contrary to what has been described in FIG. 2, the return force 200 is no longer compensated for by the thrust force which is exerted by the cleaning fluid 14 on the piston 5, with the pump 12 having been stopped. However, since, in the absence of a stop unit in a configuration of this type, the friction element 62 is not placed against the optical surface 7, the return force 200 which is exerted by the wiper blade 6 on the rod is attenuated correspondingly. The return force 200 which is exerted on the rod 4 is thus negligible, or even zero, and is thus not liable to damage the cleaning device 2 as a result of excessive mechanical stress exerted on the rod 4.

As a result of the foregoing, the configuration of the wiper blade 6 with the unilateral stop unit 63, as has just been described, i.e. with a stop unit which is positioned only on one side of the wiper blade 6, i.e. the side which faces towards the jack body 31, thus constitutes a first means 8 for limitation of, and/or compensation for, the return force 200 exerted on the rod 4.

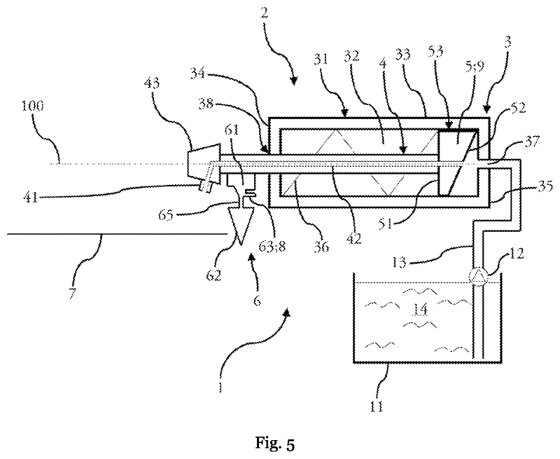

FIG. 4 is a schematic representation of a second embodiment of the cleaning device 2, in which only the piston 5 and the wiper blade 6 differ from the first embodiment. Reference will be made to the description of FIG. 1 and FIG. 2 concerning the elements which are in common to the two embodiments.

FIG. 4 illustrates the cleaning device during the first phase of cleaning of the optical surface 7, in conformity with the illustration provided in FIG. 2 for the first embodiment, i.e. when the chamber 32 is filled with cleaning fluid 14, forming the buffer area 39 which gives rise to the displacement of the piston 5 and the rod 4 in the first direction of longitudinal displacement 101. The spraying element 41 sprays the cleaning fluid 14 onto the optical surface 7, then the wiper blade 6 wipes the optical surface 7.

In this second embodiment, the wiper blade 6 comprises a bilateral stop unit 64, so that the friction element 62 is placed against the optical surface 7 in both directions of longitudinal displacement of the rod 4. The bilateral stop unit 64 extends projecting from both sides of the intermediate portion 65, i.e. with a part which extends in the direction of the jack body 31, like the unilateral stop unit of the first embodiment, and a part which extends opposite in the direction of the joining piece 43 arranged at the end of the rod 4. The friction element 62 is thus retained against the optical unit 7, irrespective of the direction of displacement of the rod 4.

As has been described for the first embodiment with reference to FIG. 2, when the rod 4 is displaced in the first direction of longitudinal displacement 101, the contact of the wiper blade on the optical surface 7 participates in exerting a return force 200 on the rod 4. The moment generated by this return force 200 which tends to misalign the rod can be compensated for by the thrust force 300 exerted by the cleaning fluid 14 on the piston 5, with the cleaning fluid 14 being conveyed into the chamber 32 at a high pressure, for example of 10 bars. However, it is possible for the cleaning system 1 to circulate the cleaning fluid 14 at a pressure which is sufficient to give rise to the displacement of the piston 5 thanks to the thrust force 300, but for this force to be insufficient to compensate for the moment generated around the lever by the return force 200. A pressure of this type can for example be 2 bars. As will be described in detail below, the second embodiment of the cleaning device 2 makes it possible to limit the stresses on the axis generated by the return force 200, in the first direction of longitudinal displacement 101, even in the case of a lower pressure.

The piston 5 according to the second embodiment thus differs from what has previously been described, in that the support face 52 has inclination relative to a plane perpendicular to the axis of longitudinal extension 100 of the rod. Thus, the support face 52 is no longer perpendicular to the axis of longitudinal extension 100, and is no longer parallel to the connection face 51. The thrust force 300 which is exerted by the cleaning fluid 14 on the piston 5, perpendicularly to the support face 52, is thus no longer parallel to the axis of longitudinal extension 100. The thrust force 300 as represented in FIG. 4 therefore has a longitudinal component, which permits longitudinal displacement of the piston 5, and a vertical component, which is parallel to the return force 200, and is directed opposite the optical surface 7. The vertical component of the thrust force 300 is represented in FIG. 4 by an opposition force 400. This force generates the creation of a moment of compensation around the lever formed at the opening 38, which moment circulates in a direction of rotation opposite to the direction of rotation of the moment generated by the return force 200. Since the vertical component of this thrust force, i.e. the opposition force 400, and the return force 200, starts on both sides of the end wall in which the lever is formed, the compensation for the moments in order to leave the rod with its axis of longitudinal extension 100 in its original position is obtained by orientation of the opposition force in the same direction as that of the return force, and thus by specific orientation of the support face 52 on which the thrust force starts.

The second embodiment of the cleaning device 2 also makes it possible to compensate for the return force 200 when the rod 4 is displaced in the second direction of longitudinal displacement. Since the support face 52 is inclined as has just been described, the connection face 51 remains perpendicular to the axis of longitudinal extension 100, such that the piston 5 has a longitudinal dimension which is variable according to the inclination of the support face 52. In particular, the piston 5 comprises a guide surface 53, the longitudinal dimension of which is the largest of the piston 5. The guide surface 53 is situated opposite the wiper blade 6 relative to a plane comprising the axis of longitudinal extension 100 of the rod, and an axis parallel to the main dimension of extension of the wiper blade 6. The guide surface 53 is configured such as to have a surface facing the tubular portion 33 which is larger than that which has been described and illustrated in the first embodiment. The size of this guide surface makes it possible to retain the rod 4 in a position parallel to its original position, despite the influence of the return force 200. The rod 4 is thus subjected less to the return force 200, and the risk of damaging the cleaning device 2 because of an excessive pressure of the of the return force 200 on the rod 4 is thus limited. In this second embodiment, the piston 5, in particular as a result of the inclination of the support face 52, thus constitutes a second means for limitation of, and/or compensation for, the return force 200 exerted on the rod 4.

Contrary to the first means for limitation and/or compensation which attenuates the return force 200 directly, the second means 9 for limitation and/or compensation compensates for the return force 200 by generating the opposition force 400. In addition, the second means 9 for limitation and/or compensation makes it possible to attenuate the effect of axial offsetting of the rod caused by the return force 200, both when the rod 4 is displaced in the first direction of longitudinal displacement 101, and in the second direction of longitudinal displacement, which is not permitted by the first means for limitation and/or compensation, which is active only when the rod 4 is displaced in the second direction of longitudinal displacement.

FIG. 5 is a representation of the cleaning device 2, combining the first embodiment and the second embodiment. In other words, in FIG. 5, the cleaning device 2 comprises the first means 8 for limitation of, and/or compensation for, the return force exerted on the rod 4, i.e. a wiper blade 6 equipped with the unilateral stop unit 63, and the cleaning device 2 also comprises the second means 9 for limitation of, and/or compensation for, the return force exerted on the rod 4, i.e. a piston 5 comprising a support face 52 which is inclined relative to a plane perpendicular to the axis of longitudinal extension 100.

During the operation of the cleaning system 1, the rod 4 is displaced initially in the first direction of longitudinal displacement, then in the second direction of longitudinal displacement. The effect of the return force on the rod 4 is thus limited firstly by the effect of the opposition force, corresponding to the vertical component of the thrust force of the cleaning fluid 14, during the entire displacement of the rod 4 in the first direction of longitudinal displacement. During this displacement, the friction element 62 is placed against the optical surface 7 by abutment against the unilateral stop unit 63. In a second stage, the rod 4 is displaced in the second direction of longitudinal displacement, and the return force is then attenuated by the absence of a stop unit placing the friction element 62 on the optical element 7. In addition, the guide surface 53 of the piston 5 also participates in the retention of the axis of longitudinal extension 100 of the rod 4 in a position substantially parallel to that of the original position of the rod during the displacement in the second direction of longitudinal displacement. The return force is thus limited in both directions of longitudinal displacement of the rod 4, which maintains the satisfactory operation of the cleaning device 2. The details concerning the operation of the means for limitation and/or compensation are presented in the description of FIG. 3 for the first means for limitation and/or compensation, and in the description of FIG. 4 for the second means for limitation and/or compensation.

It will be appreciated that the invention is not limited to the examples that have just been described, and numerous modifications can be made to these examples without departing from the scope of the invention.

The invention as it has just been described achieves well the objective which it had set out, and makes it possible to propose a cleaning device comprising a rod on which a wiper blade is positioned, as well as at least one means for limitation of, and/or compensation for, a force exerted on said rod. Variants which are not described here could be implemented without departing from the context of the invention, provided that they comprise a wiping device according to the invention. For example, the invention could extend to any type of sensors/emitters, such as acoustic or electromagnetic sensors/emitters.

What is claimed is:

1. A device for cleaning at least one optical surface of a vehicle, comprising at least one rod which extends mainly along an axis of longitudinal extension, the rod including an element for spraying a cleaning fluid, and a wiper blade which is configured to wipe the optical surface, at least one actuation means, which is controlled in order to displace the rod in a first direction of longitudinal displacement parallel to the axis of longitudinal extension, and in a second direction of longitudinal displacement, opposite the first direction of longitudinal displacement, and at least one means for limitation of, and/or compensation for, at least one return force exerted on the rod.

2. The cleaning device as claimed in claim 1, wherein the wiper blade includes a unilateral stop unit extending projecting from a single side of the wiper blade, the unilateral stop unit constituting a first means for limitation of, and/or compensation for, at least one return force exerted on the rod.

3. The cleaning device as claimed in claim 2, wherein the wiper blade includes a heel which is integral with the rod, and a friction element which is configured to wipe the optical surface, the heel and the friction element being connected to one another by an intermediate portion, the unilateral stop unit extending projecting from a single side of the wiper blade, from the intermediate portion.

4. The cleaning device as claimed in claim 2, wherein the unilateral stop unit is oriented towards the means for actuation of the rod.

5. The cleaning device as claimed in claim 1, wherein the means for actuation of the rod are in the form of a jack including a jack body delimiting a chamber and a piston which can be displaced within the jack body, the piston being connected to an end of the rod, the rod being able to emerge at least partly outside the jack body, and to return at least partly within the jack body according to a direction of displacement of the piston within the jack body, the jack body comprising including a tubular portion, a longitudinal end of which includes a first terminal wall provided with an opening which permits the passage of the rod.

6. The cleaning device as claimed in claim 5, wherein the jack body includes a second terminal wall comprising an orifice for intake of the cleaning fluid.

7. The cleaning device as claimed in claim 6, wherein the rod includes at least one channel for circulation of the cleaning fluid, which connects the orifice for intake of the cleaning fluid to the spraying element.

8. The cleaning as claimed in claim 5, wherein the piston includes a connection face from which the rod extends, and a support face which is configured to withstand a thrust force exerted by a fluid which is present in the chamber, the support face having inclination relative to a plane perpendicular to the axis of longitudinal extension of the rod.

9. The cleaning device as claimed in claim 8, wherein the piston has a guide surface with a longitudinal dimension which is larger than the mean longitudinal dimension of the piston, the guide surface being facing an area of the tubular portion of the jack body which is opposite the wiper blade relative to a plane comprising the axis of longitudinal extension extension of the rod and a main dimension of extension of the wiper blade, with the piston constituting a second means for limitation of, and/or compensation for, at least one return force exerted on the rod.

10. A system for cleaning at least one optical system of a vehicle, comprising a cleaning fluid reservoir, and a pump which transfers the cleaning fluid from the reservoir to a spraying element, and at least one cleaning device that includes at least one rod which extends mainly along an axis of longitudinal extension, the rod including the spray element for spraying a cleaning fluid, and a wiper blade which is configured to wipe the optical surface, at least one actuation means, which is controlled in order to displace the rod in a first direction of longitudinal displacement parallel to the axis of longitudinal extension, and in a second direction of longitudinal displacement, opposite the first direction of longitudinal displacement, and at least one means for limitation of, and/or compensation for, at least one return force exerted on the rod.
